(19) United States
(12) Patent Application Publication
(10) Pub. No.: US 2005/0145606 A1
(43) Pub. Date: Jul. 7, 2005

(54) Low cost actuator with 2 dimensional motion

(76) Inventor: Powell Simon, Royston (GB)

Correspondence Address: Renner Kenner Greive Bobak;Taylor & Weber, Fourth Floor, First National Tower, Akron, OH, 44308-1456, US

(21) Appl. No.: 10/504,560

(22) PCT Filed: Feb. 19, 2003
(86) PCT No.: PCT/GB03/00722

(30) Foreign Application Priority Data
Feb. 19, 2002 (GB) 0203897.4

(51) Int. Cl. B23K 26/00

(52) U.S. Cl. 219/121.61

(57) ABSTRACT

A two dimensional actuator from a substrate and arranged to bend orthogonal portions of said substrate so as to cause a combined two-dimensional motion of the substrate that is defined by the relative excitation of orthogonal portion actuators.

The use of piezo actuators as motion systems is known, as is their incorporation into frames for the provision of multiple axis actuation. This approach is adequate for the location of high cost actuators in applications such as laser positioners, where cost is secondary to accuracy and force.

Simple bender constructions can be assembled to provide multiple axis motion but the labour content of such assemblies rapidly outpaces the costs of the actuators themselves. The use of pivots is extremely undesirable in these circumstances, due to the small motion available to the actuators. To provide a low friction pivot of say 3 mm diameter, it is necessary to have at least 50 microns of freeplay between the moving parts, and this represents a significant percentage of the available motion. To provide 2 dimensions of motion in this way the linkage will have a minimum of 100 microns of float. Float can be reduced through the use needle pivots and flexing hinges but these have high cost and stiffness respectively.

Thus, the object of the present invention is to provide a low cost actuator with reduced pivot losses.

According to the present invention there is provided an actuator formed from a substrate and arranged to bend orthogonal portion of said substrate so as to cause a combined two-dimensional motion of the substrate that is defined by the relative excitation of orthogonal portion actuators.

In order that the present invention be more readily understood, embodiments thereof will now be described with reference to the accompanying drawings, in which:—

FIG. 1 is a perspective view of a U-shaped substrate for use in the present invention;

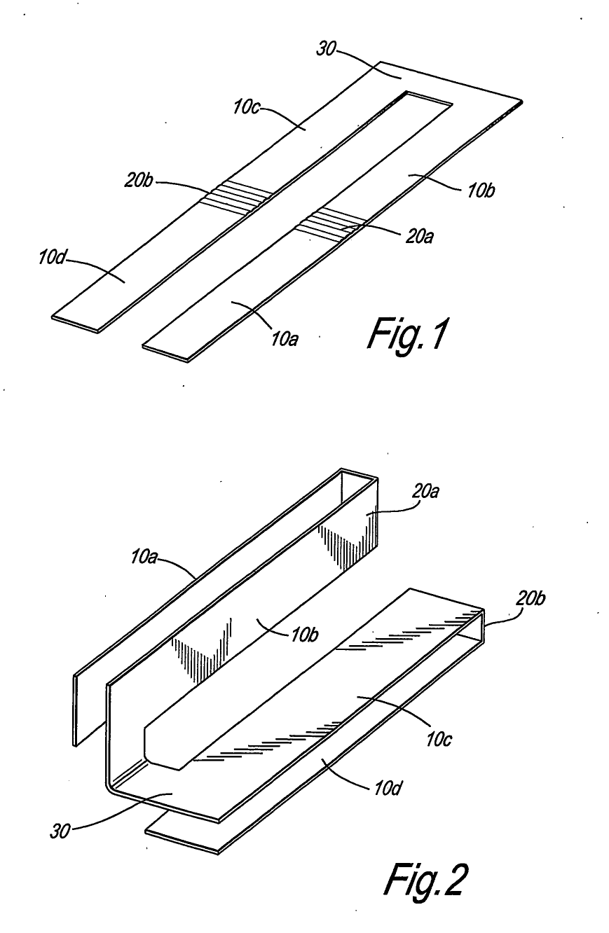

FIG. 2 is a perspective view of the substrate shown in FIG. 1 in an intermediate condition;

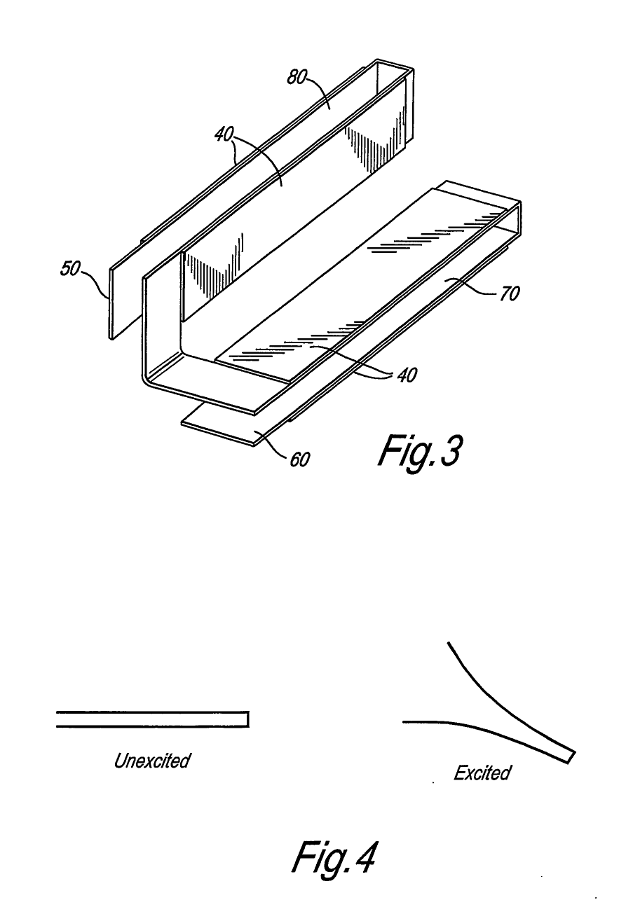

FIG. 3 is a perspective view of the substrate shown in FIG. 2 with piezo-ceramic material attached;

FIG. 4 is a diagram for explaining the motion of the end of the substrate shown in FIG. 3;

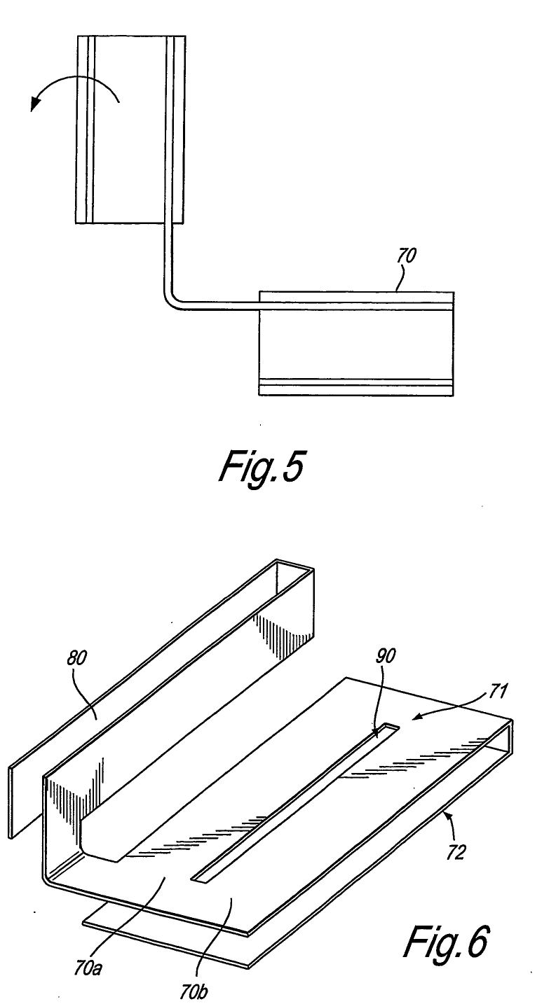

FIG. 5 is a diagram for explaining further motion of the end of the substrate shown in FIG. 3;

FIG. 6 is a perspective view of a modification to the substrate shown in FIG. 2;

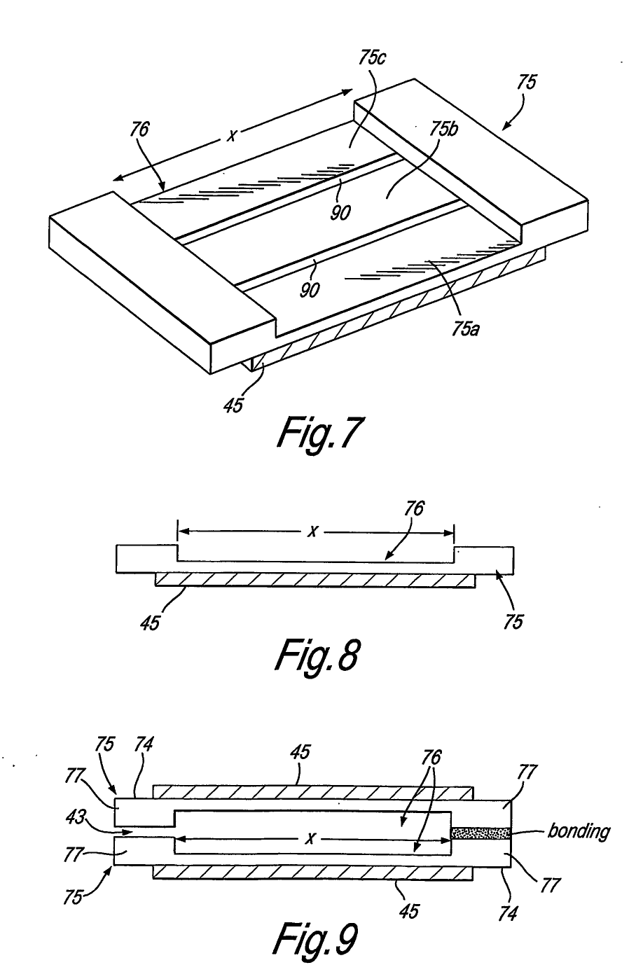

FIG. 7 is a perspective view of an etched plate which may be utilised by the present invention; and

FIG. 8 is a side view of the etched plate in FIG. 7.

FIG. 9 is a side view of a hairpin arrangement using the etched plate shown in FIG. 7.

The present invention provides an active material actuator that utilises the d31 mode of operation to bend multiple and orthogonal portions of a laminar substrate to provide a combined XY motion that is defined by the relative excitation of the orthogonal portion actuators.

A suitable substrate such as kovar metal is formed as shown in FIG. 1. The shape comprises four planar surfaces (10a-10d) where two surfaces (10a,10b) are colinear and these two sets of colinear surfaces are separated by a bridging portion (30) to form a flat U-shape. To aid the formation of the final shape the area (20a) between the two colinear surfaces (10a,10b) and the area (20b) between the two colinear surfaces (10c,10d) can helpfully be thinned by either acid etching or reduction by a necking punch, but this is not essential to the operation of the final device save in that it will affect the stiffness and appropriate measures must be taken to maintain the stiffness.

A series of folding operations are now performed upon the flat shape. Each leg is folded at the centre of the area (20a,20b) between the colinear portions, but one part is folded upwards and the other is folded downwards. A further orthogonal bend is made in the centre of the bridging portion (30) to create the form shown in FIG. 2.

In FIG. 3 each of the planar surfaces (10) now has adhered to it a poled piezo ceramic plate (40). The technology of both adhesion and the manufacture of the piezo ceramic plates is known and does not require specific discussion here. The plates are fixed to the outer surfaces of the folded portions to form two hairpin shapes that open outwards when the piezo ceramic plates are excited by the application of a suitable voltage. The plates 40 can be adhered prior to folding if desired.

FIG. 4 shows the motion of the individual hairpins as they are excited. This motion is commonly termed d₃₁ actuation because it is the contraction of the second and third dimensions in response to the increase of the third plane that is used. The third plane is the plane of the field, hence the terms 31, 32 and 33, where the first digit signifies the applied field direction and the second digit describes the motion plane.

Consider now the behaviour of a point on the free end (50) of the second actuator (50) when the system is fixed at the other free end (60). Excitation of the first hairpin (70) will cause the point (50) to rise in the Y plane. The elevation will be directly proportional to the applied charge, within the limits of material hysteresis and other limitations, up to the maximum strain achievable with the specific material. Consider now the application of a second charge to the plates on the second hairpin (80) which is perpendicular to the first. The notional spot (50) will now move in the X plane.

It is a useful feature of piezo and other electro ceramic actuators that their shape change is proportional to the applied field. Electro-strictive and piezo electric materials respond to electric field, whilst magneto-strictive materials respond to magnetic fields. Any such materials can be usefully substituted for the described materials to respond to one or more stimuli. For example, the position of the point (50) can be determined by one magnetic and one electro strictive actuator to measure two phenomena.

The proportional or near proportional nature of the described materials makes it possible to apply known levels of stimulus to the two actuators and to position the notional spot (50) anywhere in a box the size of the stroke limit of each actuator. This makes the actuator suitable for the positioning of fibreoptics, for example, moving a signal fibre between a number of receivers.

Consider further the coordinated stimulation of the two actuators by a simple sinusoidal signal. If the input to one actuator is sinusoidal and the input to the second is synchronous but inverted the net position of the notional point will describe a circle proportional to the signal amplitude. This motion is shown in FIG. 5. In order to maintain a circular action the start point for the circle requires an initial excitation of the vertical actuator (70) to the target radius.

To make a simple motor the combined output can be attached to a crank having a radius equivalent to one half of the total available stroke. The output from the crank is simply converted to a motor output by the affixation of a flywheel or gear. To make a vibration motor the output shaft can simply be fitted to a rotating eccentric.

The available force from each actuator will not be equal because the vertical actuator has to lift the lateral one, assuming that gravity is working in the normal direction. Even if the parts are oriented to compensate for the gravitational effects the stiffness of the first actuator must be higher to drive the increased mass of the second actuator.

FIG. 6 shows an improved construction wherein the lifter actuator comprises two hairpins 70a, 70b separated by a slot 90. The slot may be inserted in the upper surface 71 or lower surface 72 of the lifter actuator. Additionally, the surfaces 71,72 of each hairpin 70a,70b may have adhered to them a poled piezo ceramic plate.

It is beneficial and superior for the lower actuator to comprise multiple hairpins rather than simply using wider plates because the multiple plates have the same anisotropy as the single plates and so the stroke is maintained whilst increasing the force output.

Alternatively, the multiple plate arrangement of FIG. 6 may be formed from two slotted substrates being placed one over the other with their slots in register and whose end portions are connected together at one end to form a hairpin.

It will be appreciated that the multiple plate arrangement may have an unlimited number of hairpins being formed as the lifter actuator, each hairpin being separated by a slot 90. The slot extends along the upper surface 71 and has a corresponding slot on the lower surface 72 but is of a length such that there is a rigid connection between each hairpin at each end of the slot. Furthermore, the multiple hairpin arrangement described above may be utilised in the other orthogonal actuator 80.

In addition, it is advantageous but not essential for each hairpin to have adhered to it an electro ceramic plate which is preferably a piezo ceramic plate FIG. 7 shows a plate 75 which may be used in the present invention. The plate 75 has an etched portion 76 and a plurality of slots 90, in this case two slots separating three surfaces 75a,75b,75c of the plate 75. The underside of each surface 75a,75b,75c may have adhered to it a piezo-ceramic plate 45 to provide movement of the plate 75 when the piezo ceramic plate 45 is excited. The piezo plate is preferably of a size such that it extends beyond the width x of the etched portion 76 as shown in FIG. 8.

The etched portion 76 of the plate 75 may have a layer of metal such as copper within the etched portion to compensate for the thermal effects caused by differences between the coefficient of thermal expansion of the plate 75 in that of the piezo plate. Additionally, the plate 75 is typically formed from a substrate such as kovar. The etching process is known in the art so will not be discussed in detail herein, however etching is typically achieved using chemical etching or electrochemical machining.

The plate 75 may be utilised in the present invention by acting as the lifter actuator 70 but may also provide a replacement for the other orthogonal actuator 80. The construction of this type of etched plate 75 with slots 90 allows for multiple plates to be formed from one metal substrate thus providing less resistance to deflection from stiffness as would be the case with a single plate.

FIG. 9 shows an embodiment of the hairpin arrangement which is formed when the etched plate is utilised as an orthogonal actuator in the present invention.

The hairpin arranged is formed using two etched plates 75 in a configuration so that the etched portion 76 of each plate 75 faces one another. Furthermore, the slots of one plate are positioned so as to directly correspond to the slots of the other plate. The length of each slot is to the extent that it does not reach the peripheral areas 77 which are the unetched respective ends of the plate 75. Thus, the slots extend only within the width of the etched portion of the plate. Additionally, the end of the slots will be shaped but preferably rounded.

Both the etched plates are bounded together to form the hairpin at one of the facing peripheral ends 77 of each etched plate. Accordingly there will exist a gap 43 between the plates at the opposite peripheral end.

The outer surfaces 74 of each etched plate 75 may have adhered to it an electro ceramic plate 45 such as a piezo ceramic plate with the length of the piezo plate extending beyond of the length of each slot and on to the peripheral areas 77.

A useful feature of the plate 75 is that it may be of any length and slots can be inserted into the plate depending on the force which is required when the piezo ceramic plates attached to the plate 75 are excited. Furthermore, the slots 90 provide uniform behaviour along the length of the plate 75 and length is proportional to strength.

Although the hairpin arrangement in FIG. 9 shows the use of two etched plates being connected together at one end to form a hairpin, the hairpin may be formed from one plate with separate etched portions. The plate may be folded about an area separating the etched portions so as to form a hairpin arrangement from a single plate hence removing the need to band more than one plate together.

It will be appreciated that the construction described in FIGS. 7 and 8 may be used independently from the folded construction described above to provide an actuator with increased force output due to the use of a plate with multiple slots.

1. An actuator arrangement formed from a substrate folded to form orthogonal portions; and each provided with a controllable actuation layer to form an actuator; whereby a combined two-dimensional motion of a part of the substrate by relative excitation of the orthogonal portion actuators.

2. An actuator arrangement according to claim 1 wherein the two dimensional motion is an XY motion such that one end of the substrate moves in the Y plane when a first orthogonal portion actuator is excited and said end of the substrate moves in the X plane when a second orthogonal portion actuator is excited.

3. An actuator arrangement according to claim 1, wherein the actuation layer of at least one of said orthogonal portion actuators is a piezo-electric layer.

4. An actuator arrangement according to claim 1, wherein the actuation layer of at least one of said orthogonal portion actuators is a magneto-strictive layer.

5. An actuator arrangement according to claim 1 which utilizes the d31 mode of operation.

6. An actuator arrangement according to claim 1 wherein each of the orthogonal portions are in the shape of a hairpin.

7. An actuator arrangement according to claim 6 wherein at least one of the orthogonal portions comprises multiple hairpins separated by slots.

8. A piezo ceramic actuator comprising a planar metal member provided with an elongate slot which is parallel to one edge of the member and is located wholly within the periphery of the member whereby to create end portions at each end of the slot and form a plurality of actuator sections.

9. An actuator according to claim 8 wherein two planar metal members are placed one over the other with their slots in register and whose end portions are connected together at one end to form a hairpin.

10. An actuator according to claim 8 wherein actuator layers are formed on the planar metal member on either side of the slot or each slot.

11. An actuator according to claim 8, wherein the actuation layer is a piezo-electric layer.

12. An actuator according to claim 8, wherein the actuation layer is a magnetostrictive layer.

13. A actuator according to claim 10 wherein one major surface of the planar metal plate is reduced in thickness between the end portions.

14. An actuator according to claim 13 wherein the reduced thickness portion is provided with a layer of metal in order to alter the thermal characteristics of the metal member.

15. An actuator according to claim 14 wherein the metal is copper.

16. An actuator according to claim 13 wherein the actuator layers extend beyond the length of the slot or each slot and on to the end portions.
